(19) United States
(12) Patent Application Publication
(10) Pub. No.: US 2008/0173151 A1
(43) Pub. Date: Jul. 24, 2008

(54) SAW BLADE GUIDE AND COMPONENTS THEREFOR

(76) Inventor: Edward E. Belfiglio, Owensboro, KY (US)

Correspondence Address: C RICHARD MARTIN;MARTIN & MARTIN, ATTORNEYS AT LAW, PC, PO BOX 29, BOONVILLE, IN, 47601, US

(21) Appl. No.: 12/024,886

(22) Filed: Feb. 1, 2008

Related U.S. Application Data
(63) Continuation-in-part of application No. 11/027,182, filed on Dec. 28, 2004, now Pat. No. 7,325,473.
Application No. 11/027,182 is a continuation-in-part of application No. 09/644,484, filed on Aug. 23, 2000, now Pat. No. 6,889,589.

(51) Int. Cl. B27B 13/10; B26D 1/54; B23D 55/08

(52) U.S. Cl. 83/820; 83/824; 83/829

(57) ABSTRACT

An improved guide for stabilizing the saw blade of a saw mill assembly is provided. The guide includes a first guide block assembly and a second guide block assembly. The first guide block assembly comprises a first guide block having a first surface for engaging a first surface of the saw blade and a second opposing surface, a first mounting plate affixed to the second opposing surface of the first guide block proximate a first end thereof, and a first positioning shaft having a first end affixed to the first mounting plate proximate to a second end thereof, and a second end received in a mounting bracket of a saw mill. The second guide block assembly similarly comprises a second guide block having a first surface for engaging a second surface of the saw blade and a second opposing surface; a second mounting plate affixed to the second opposing surface of the second guide block proximate a first end thereof; and a second positioning shaft having a first end affixed to the second mounting plate proximate to a second end thereof, and a second end received in the mounting bracket of the saw mill.

### BACKGROUND OF THE INVENTION

This application is a Continuation-in-part of application Ser. No. 11/027,182 filed on Dec. 28, 2004, which is a Continuation-in-part of application Ser. No. 09/644,484 filed on Aug. 23, 2000, now U.S. Pat. No. 6,889,589.

This invention relates generally to saw blade guides and blocks or inserts used on such guides to stabilize a circular saw blade or a band saw blade of a sawmill. More specifically, this invention relates to a saw blade guide that incorporates a rotational device for orienting said saw blade guide to an optimum position and providing microscopic adjustment of said saw blade guide on a saw blade and the inserts for the saw blade guide. Both the upper and lower blade guides can be adjusted from above the blade.

Generally, saw blade guides have long been known and used for stabilizing both circular saw blades and band saw blades. While some early saw blade guides, such as those disclosed in U.S. Pat. No. 425,105 to R. McChesney issued on Apr. 8, 1890, use inserts or blocks which are removably fastened to the saw blade guide by means of threaded fasteners, none of those prior art inserts use cap screws for holding the inserts in place which are countersunk or counterbored within the insert or guide block which are threadably inserted onto and removed from a blade opposing surface of the insert and guide surface and remove from a blade opposing surface of the insert and guide surface upon which the insert is mounted.

Moreover, none of the prior art saw guides and inserts incorporate a system for rotating a rectangular insert on a cylindrical head which incorporates a threaded rod. The cylindrical head and threaded rod allows for microscopic adjustment of the saw guide and orientation of the rectangular guide and insert for optimum stabilization, and a securing nut for holding the guide in its optimum position.

None of the prior art devices provide a pair of guides that can be adjusted to accommodate workpieces of varied width.

Further, none of the prior art saw blade guides are configured to be adjusted from only one side of the blade, preferably the upper side.

### SUMMARY OF THE INVENTION

It is the object of my invention to provide guides for a saw mill wherein both the upper and lower guides are micro-adjustable, thus eliminating shims and guesswork.

It is a further object of my invention to provide a novel set of micro-adjustable guides for a saw mill wherein both the upper and lower guides are adjusted from the top of the unit.

It is yet a further object of my invention to provide a saw mill wherein the position of the guides may be quickly and easily adjusted to accommodate workpieces of varied widths.

Further objects of the invention are to provide bolt-on adjustable guides for a saw mill that require no modifications to the saw, and to provide guides with removable inserts that may be replaced without the need to replace the entire guide.

Yet a further object of the present invention is to provide a mechanism for de-dusting the workpiece as it is sawed such that a secondary operation of removing dust from the workpiece is not required.

Briefly, in accordance with a first aspect of my invention there is provided a guide for stabilizing a saw blade comprising a first guide block assembly and a second guide block assembly. The first guide block assembly comprises a first guide block having a first surface for engaging a first surface of said saw blade and a second opposing surface; a first mounting plate affixed to said second opposing surface of the first guide block proximate a first end thereof; and a first positioning shaft having a first end affixed to said first mounting plate proximate to a second end thereof, and a second end received in a mounting bracket of a saw mill. The second guide block assembly similarly comprises a second guide block having a first surface for engaging a second surface of said saw blade and a second opposing surface; a second mounting plate affixed to said second opposing surface of said second guide block proximate a first end thereof; and a second positioning shaft having a first end affixed to said second mounting plate proximate to a second end thereof, and a second end received in said mounting bracket of said saw mill.

The second positioning shaft according to this embodiment of the present invention is coaxial with said first positioning shaft. The first positioning shaft is hollow and the second positioning shaft is coaxially received in the hollow opening therein. The second positioning shaft further includes threads formed in the outer surface thereof for rotatably engaging corresponding threads on the inner surface of the hollow first positioning shaft. The first positioning shaft further includes threads formed in the outer surface thereof for rotatably engaging corresponding threads formed in an opening in the mounting bracket.

A first securing nut threadably engages the outer threaded surface of the first positioning shaft, and is rotatable with respect to the first positioning shaft such that a surface of the securing nut engages a first surface of the mounting bracket upon rotation into engagement therewith thereby securing the position of the first guide block relative to the first surface of the saw blade. A second securing nut threadably engages the outer threaded surface of the second positioning shaft, and is rotatable with respect to the second positioning shaft such that a surface of the securing nut engages an upper end surface of said first positioning shaft upon rotation into engagement therewith thereby securing the position of the second guide block relative to the second surface of the saw blade. The free ends of the first and second positioning shafts may have a polygonally shaped head for engagement by a tool such as a wrench.

The first guide block assembly is positioned on the upper side of the saw mill and the second guide block assembly is positioned on the lower side of the saw mill, and the mounting bracket is positioned on the upper side of the saw mill.

According to another aspect of the invention the mounting bracket includes means for adjusting the lateral position of the guide in relation to the longitudinal axis of the saw blade. The guide may further include a de-dusting mechanism having an air supply hose for supplying compressed air to a nozzle positioned between the first guide block assembly and second guide block assembly along a back edge of the saw blade.

According to one preferred embodiment, the adjusting means comprises a plurality of holes disposed in a surface of the mounting bracket and aligned along a longitudinal axis thereof, a mounting arm having one or more openings in a surface thereof positioned on the saw mill, and one or more fasteners inserted through said one or more openings in the mounting arm and a corresponding one or more of the plurality of holes in the mounting bracket. The one or more fasteners are threaded bolts and the plurality of holes each include corresponding female threads.

According to another alternative embodiment the adjusting means comprises a longitudinal slot formed in a surface of the mounting bracket parallel to the longitudinal axis of the saw blade, a mounting arm having one or more openings in a surface thereof positioned on the saw mill, and one or more fasteners, each having an enlarged head slidably positioned in the slot and an elongated shaft extending upwardly therefrom through said one or more openings in the mounting arm. One or more threaded nuts are provided for engaging threaded portions of the elongated shafts of said one or more fasteners.

According to a further aspect of the present invention, a guide assembly for saw mill having an adjustable width cutting area is provided. The guide assembly comprises a first mounting bracket having a first guide block assembly removably affixed thereto removably affixed to a first mounting arm of the saw mill, and a second mounting bracket having a second guide block assembly removably affixed thereto removably affixed to a second mounting arm of the saw mill. The cutting area is defined by the space between said first guide block assembly and said second guide block assembly. The guide assembly further includes means for adjusting the lateral position of the first guide block relative to the second guide block.

According to one embodiment of the invention, the adjusting means comprises a plurality of holes disposed in a surface of the second mounting bracket and aligned along a longitudinal axis thereof, one or more openings in a surface of the second mounting arm; and one or more fasteners inserted through said one or more openings in the second mounting arm and a corresponding one or more of the plurality of holes in the second mounting bracket. The one or more fasteners are preferably threaded bolts and said plurality of holes each include corresponding female threads.

According to an alternative embodiment of the invention, the adjusting means comprises a longitudinal slot formed in a surface of the second mounting bracket parallel to the longitudinal axis of the saw blade; one or more openings in a surface of said second mounting arm; and one or more fasteners, each having an enlarged head slidably positioned in the slot and an elongated shaft extending upwardly therefrom through said one or more openings in the second mounting arm. One or more threaded nuts are also provided for engaging threaded portions of the elongated shafts of said one or more fasteners.

The guide assembly may further comprise a de-dusting mechanism having an air supply line for supplying compressed air to a nozzle positioned between the first guide block assembly and second guide block assembly along a back edge of the saw blade. The first guide block assembly of the saw mill comprises a first guide block having a first surface for engaging a first surface of said saw blade and a second opposing surface; a first mounting plate affixed to said second opposing surface of the first guide block proximate a first end thereof; and a first positioning shaft having a first end affixed to said first mounting plate proximate to a second end thereof, and a second end received in a mounting bracket of a saw mill. The second guide block assembly of the saw mill comprises a second guide block having a first surface for engaging a second surface of said saw blade and a second opposing surface; a second mounting plate affixed to said second opposing surface of said second guide block proximate a first end thereof; and a second positioning shaft having a first end affixed to said second mounting plate proximate to a second end thereof, and a second end received in said mounting bracket of said saw mill.

These and other objects, features and advantages of the present invention will become apparent to those skilled in the art from the following detailed description and attached drawings upon which, by way of example, only the preferred embodiments of my invention are illustrated.

### BRIEF DESCRIPTION OF THE DRAWINGS

FIG. 1 shows a side cross-sectional view of a guide for stabilizing a saw blade according to a preferred embodiment of the present invention.

FIG. 2 shows a perspective view of a saw mill according to a further embodiment of the present invention incorporating a pair of the guides for stabilizing a saw blade shown in FIG. 1.

FIG. 3 shows an exploded perspective view of a pair of guides for stabilizing a saw blade shown in FIG. 2, illustrating a preferred embodiment of the present invention.

FIG. 4 shows a perspective view of a saw mill according to a further embodiment of the present invention incorporating a pair of the guides for stabilizing a saw blade shown in FIG. 1.

FIG. 5 shows an exploded perspective view of a pair of guides for stabilizing a saw blade shown in FIG. 4, illustrating a preferred embodiment of the present invention.

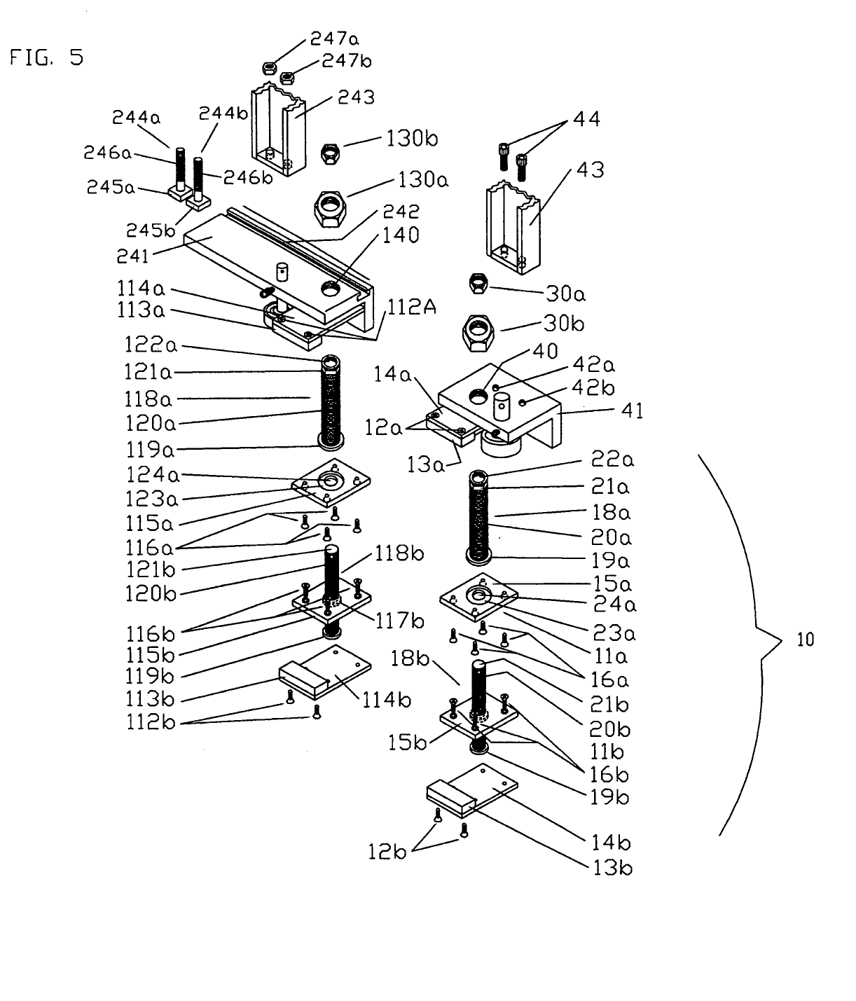

FIG. 6 shows a perspective view of a saw mill according to a further alternative embodiment of the present invention incorporating a pair of the guides for stabilizing a saw blade shown in FIG. 1, and a de-dusting mechanism.

FIG. 7 shows a perspective view of a saw mill according to a further alternative embodiment of the present invention incorporating a pair of the guides for stabilizing a saw blade shown in FIG. 1 and a de-dusting mechanism.

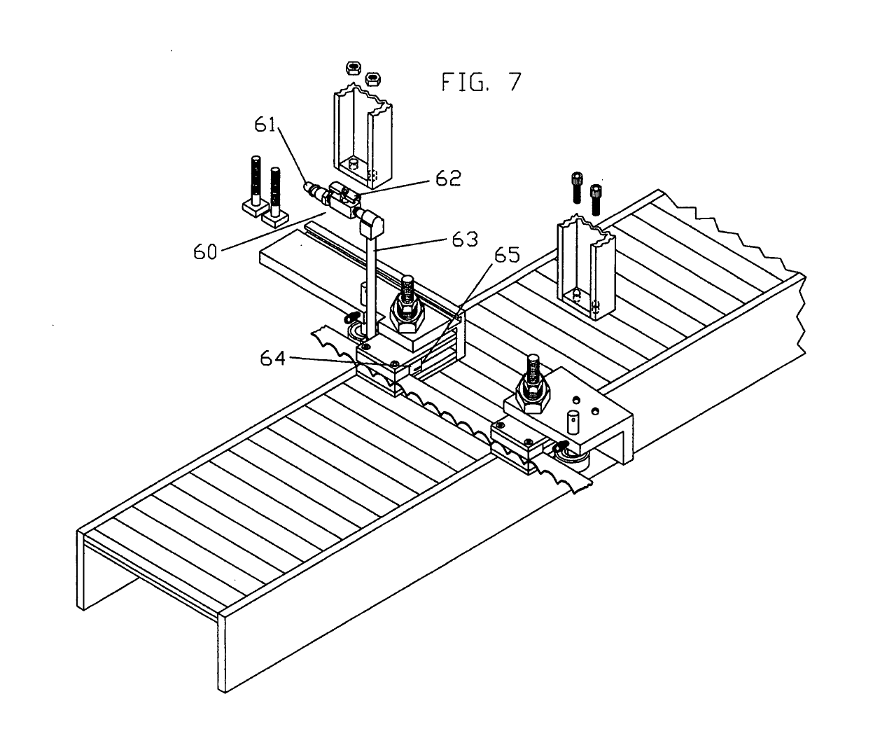

### DESCRIPTION OF THE PREFERRED EMBODIMENTS

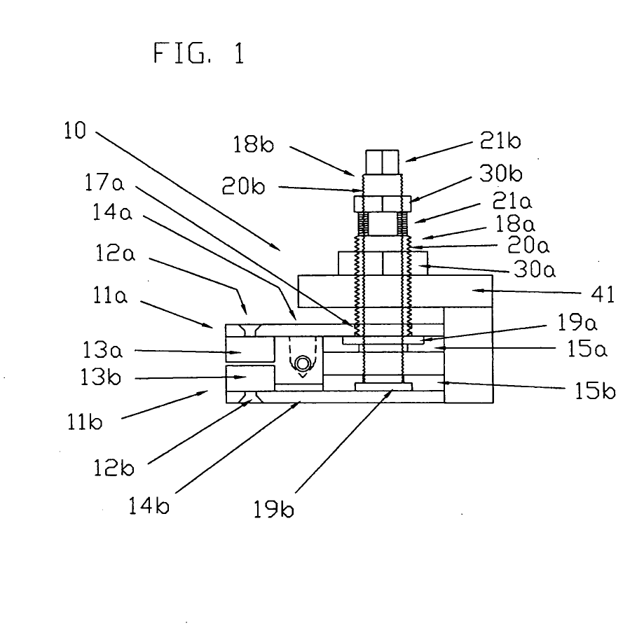

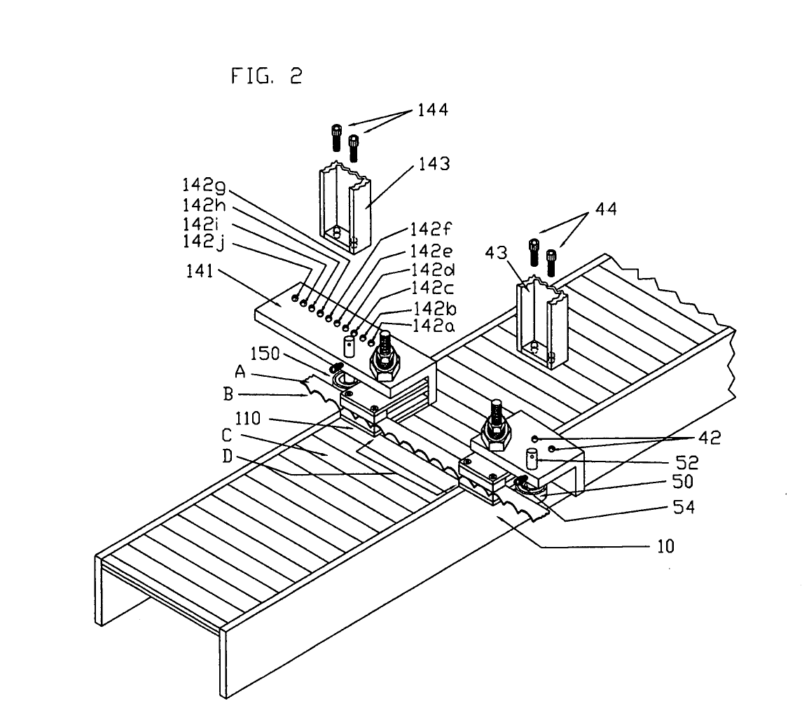

Referring now to the drawings and, in particular, to FIG. 1, there is shown in a preferred embodiment of my invention, an improved blade guide 10, for use in a conventional band saw mill assembly to stabilize a band saw blade A having cutting teeth B. The improved blade guide includes an upper surface guide assembly 11a, and a lower surface guide assembly 11b positioned on opposing surfaces of the blade A, as shown in FIG. 2, which limits or effectively prevents lateral vibration, bending or dishing of the blade during sawing operations.

As best shown in FIG. 2, a third blade guide, preferably in the form of a back-up bearing 50 may be further positioned along the smooth edge of the blade to prevent longitudinal vibration or displacement of the blade. The back-up bearing 50 is double shielded, pre-lubed and mounted on a cam for easy adjustment. The cam is positioned on the end of a shaft 52, which passes through an opening in the mounting bracket 42, and is removably secured thereto by a setscrew 54.

The upper surface guide assembly 11a includes an upper guide block 13a affixed to a lower surface of a mounting plate 14a by one or more fasteners, such as cap screws 12a and 12b. The guide block 13a is made of a super abrasion resistant alloy, as described in U.S. Pat. No. 6,889,589 that can be re-ground many times for long life. A base plate 15a is also affixed to a lower surface of the mounting plate 14a adjacent to the guide block 13a by one or more fasteners, such as cap screws 16a. The mounting plate 14a, guide block 13a and base plate 15a are preferably rectangular in shape as shown in the drawings, however, other polygonal shapes and configurations are also contemplated. An opening 17a disposed in the center region of the mounting plate 14a is configured to rotatably receive a threaded shaft 18a therein. The shaft 18a has an enlarged head section 19a at a first end thereof, a male-threaded section 20a along at least a portion of the length thereof, and a hexagonal head 21a at a second end thereof, and has a longitudinal opening 22a throughout the entire length thereof.

The opening 17a in the mounting plate 14a is of a diameter larger than the outer diameter of the threaded section 20a of the shaft 18a, but smaller in diameter than the diameter of the enlarged head section 19a. Therefore, in assembling the blade guide, the length of the shaft 18a is passed through the opening 17a until the enlarged head section 19a comes into contact with a bottom surface of the mounting plate 14a, such that the shaft 18a can rotate freely in relation to the mounting plate 14a.

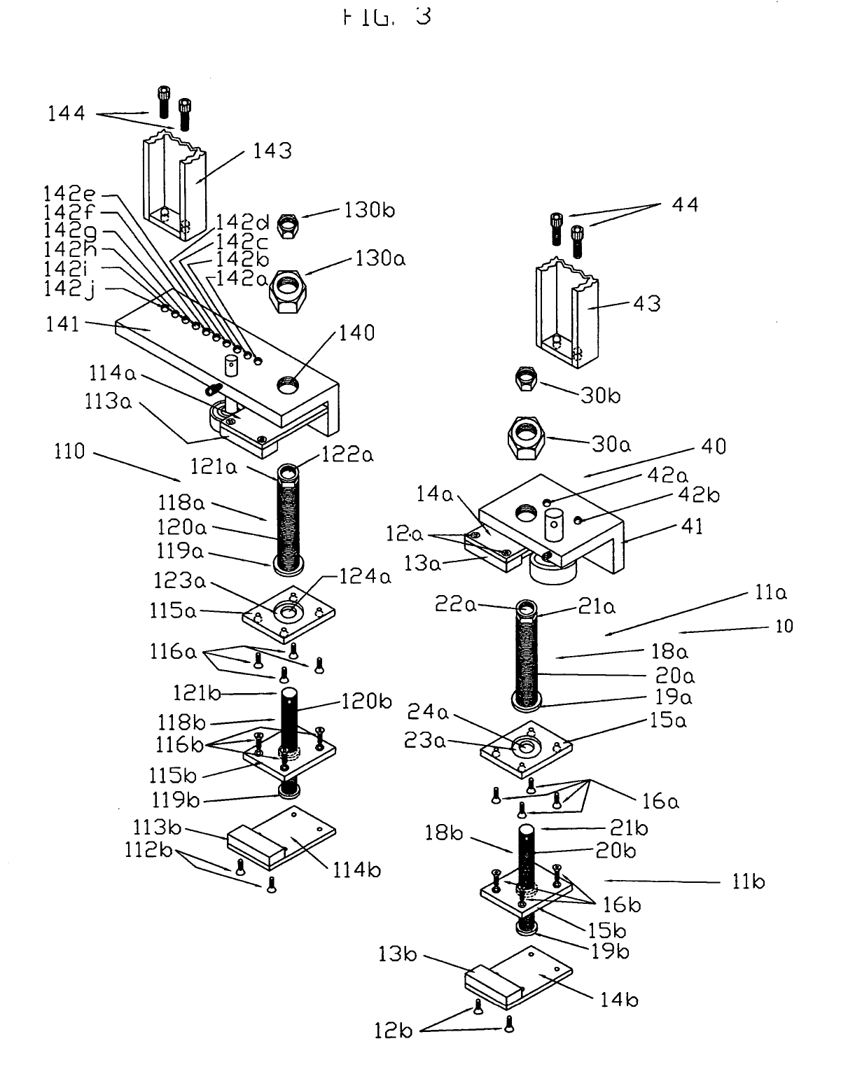

The base plate 15a also includes one or more untapped screw holes therein for receiving a corresponding one or more fasteners 16a. According to the shown preferred embodiment, four holes are formed in the base plate 15a. Each screw hole may have a recessed frustroconical countersunk or counterbored portion formed above the screw hole so that a cap screw, such as is shown at 16a in FIG. 3, can be inserted therein to a level below the upper surface of the base plate 15a. Preferably the cap screws 16a, as shown in the example of FIG. 3, is of the hex socket type for use of a standard hex wrench to secure and loosen the base plate 15a from the corresponding mounting plate 14a, although other types of commonly known cap screws and fasteners could be employed wherein a standard tool such as a screwdriver could be used to secure and remove the blade guide insert from the base plate. The base plate 15a further includes a recess 23a formed in the upper surface thereof and extending partially through the base plate 15a for rotatably receiving the enlarged head 19a of the shaft 18a therein. A smaller concentric opening 24a is provided in the base plate 15a. The opening 24a in the base plate 15a is of a diameter larger than the outer diameter of the threaded section 20b of the second shaft 18b, thereby permitting the second shaft 18b to pass therethrough and through the opening 22a of the first shaft 18a.

The first threaded shaft 18a is threadably received in a threaded opening 40 disposed in a mounting bracket 41 of the saw mill assembly. The bracket is removably mounted to an arm 43 of the saw mill assembly by one or more fasteners, such as cap screws 44 that pass through holes in the lower end of the saw mill arm 43 and engage threaded holes 42a, 42b in the mounting bracket 41.

The position of the upper guide block 13a relative to the blade A can be adjusted by rotation of the shaft 18a in relation to the mounting bracket 41 thereby effecting linear translational movement of the shaft 18a along its longitudinal axis. Rotation of the shaft 18a relative to the mounting bracket 41 can be effectuated by engaging the hexagonal head 21a with an appropriately sized and shaped tightening tool such as a wrench. The hexagonal configuration of the second end of the shaft 18a is merely one common example of a head configuration that permits the use of ordinary hand tools to impart rotation to the shaft. It is understood and contemplated that the head on the second end of the shaft may have different geometric configurations depending upon the tool that the user desires to employ. By way of example only, and not to limit the possible structures contemplated, the head 21a could be square to accommodate certain wrenches, slotted to accommodate a screwdriver, or a hex socket type for use of a standard hex wrench to secure.

A jam nut 30a is provided to fixedly secure the upper surface guide assembly 11a from vertical and rotational movement. The inner threaded surface of the jam nut 30a threadably engages the threaded region 20a of the shaft 18a. By rotating the jam nut 30a in relation to the shaft, the nut can be translated along the longitudinal axis of the shaft 18a. When the nut is translated to the lowermost position on the shaft 18a, a lower surface of the nut 30a frictionally engages the upper surface of the mounting bracket 41, thereby preventing vertical and rotational movement of the mounting plate 14a and guide block 13a.

The lower surface guide assembly 11b includes a lower guide block 13b affixed to an upper surface of a mounting plate 14b by one or more fasteners, such as set screws 12b. A base plate 15b is also affixed to an upper surface of the mounting plate 14b adjacent to the guide block 13b by one or more fasteners, such as set screws 16b. The mounting plate 14b, guide block 13b and base plate 15b are preferably rectangular in shape as shown in the drawings, however, other polygonal shapes and configurations are also contemplated. An opening 17b disposed in the center region of the base plate 15b is configured to rotatably receive a threaded shaft 18b therein. The shaft 18b has an enlarged head section 19b at a first end thereof, a male-threaded section 20b along at least a portion of the length thereof, and a hexagonal head 21b at a second end thereof.

The opening 17b in the base plate 15b is of a diameter larger than the outer diameter of the threaded section 20b of the shaft 18b, but smaller in diameter than the diameter of the enlarged head section 19b. Therefore, in assembling the blade guide, the length of the shaft 18b is passed through the opening 17b until the enlarged head section 19b comes into contact with a lower surface of the base plate 15b, such that the shaft 18b can rotate freely in relation to the base plate 15b.

The base plate 15b also includes one or more untapped screw holes therein for receiving a corresponding one or more fasteners 16b. According to the shown preferred embodiment, four holes are formed in the base plate 15b. Each screw hole may have a recessed frustroconical countersunk or counterbored portion formed above the screw holes so that a cap screw, such as is shown at 16b in FIG. 3, can be inserted therein to a level below the upper surface of the base plate 15b. Preferably the cap screws 16b, as shown in the example of FIG. 3, is of the hex socket type for use of a standard hex wrench to secure and loosen the base plate 15b from the corresponding mounting plate 14b, although other types of commonly known cap screws and fasteners could be employed wherein a standard tool such as a screwdriver could be used to secure and remove the blade guide insert from the base plate. The base plate 15b further includes a recess 23b formed in the lower surface thereof and extending partially through the base plate 15b for rotatably receiving the enlarged head 19b of the shaft 18b therein. A smaller concentric opening 24b is provided in the base plate 15b. The opening 24b in the base plate 15b is of a diameter larger than the outer diameter of the threaded section 20b of the second shaft 18b, thereby permitting the second shaft 18b to pass therethrough. The second shaft 18b then passes through the opening 24a in the upper base plate 15a, and into the opening 22a of the first shaft 18a.

The inner surface of the opening 22a of the first threaded shaft 18a is threaded so as to engage the threaded portion 20b of the second threaded shaft 18b. When assembled for use, the second threaded shaft 18b extends completely through opening 22a in the first threaded shaft 18a such that the end 21b of the second shaft 18b extends upwardly beyond the end 22a of the first shaft 18a. Accordingly, both guides 11a, 11b are micro-adjusted from the top of the guide 10.

The position of the lower guide block 13b relative to the blade A can be adjusted by rotation of the shaft 18b in relation to the upper shaft 18a while the upper shaft 18a is secured against rotation by securing nut 30a, thereby effecting linear translational movement of the shaft 18b along its longitudinal axis. Rotation of the shaft 18b relative to the first shaft 18a can be effectuated by engaging the hexagonal head 21b with an appropriately sized and shaped tightening tool such as a wrench. The hexagonal configuration of the second end of the shaft 18b is merely one common example of a head configuration that permits the use of ordinary hand tools to impart rotation to the shaft. It is understood and contemplated that the head on the second end of the shaft may have different geometric configurations depending upon the tool that the user desires to employ. By way of example only, and not to limit the possible structures contemplated, the head 21b could be square to accommodate certain wrenches, slotted to accommodate a screwdriver, or a hex socket type for use of a standard hex wrench to secure.

A second jam nut 30b is provided to fixedly secure the lower surface guide assembly 11b from vertical and rotational movement. The inner threaded surface of the jam nut 30b threadably engages the threaded region 20b of the shaft 18b. By rotating the jam nut 30b in relation to the shaft, the nut can be translated along the longitudinal axis of the shaft 18b. When the nut is translated to the lowermost position on the shaft 18b, a lower surface of the jam nut 30b frictionally engages the upper end 21a of the upper shaft 18a, thereby preventing vertical and rotational movement of the mounting plate 14b and guide block 13b.

According to a preferred use and operation of the embodiment of the present invention shown in FIGS. 2-3, two guide assemblies 10, 110 are utilized to stabilize a saw blade A. A cutting area D is defined above a conveyor C that feeds material to be cut between the trailing edge guide assembly 10 and leading edge guide assembly 110. The components of the leading edge guide assembly 110 are identical to the components of the trailing edge guide assembly 10, wherein like numerals (ie, 14, 114) indicate like component parts. Accordingly, the component parts of the leading edge guide assembly will not be described further.

The trailing edge guide assembly 10 is secured to mounting bracket 41 via engagement of the upper threaded shaft 18a in the threaded opening 40 as described above. The mounting bracket 41 is removably secured to a first mounting arm 43 of the saw mill assembly by one or more fasteners, such as cap screws 44 which pass through corresponding openings in a lower surface of the mounting arm 43 and engage corresponding threaded holes 42a, 42b formed in the mounting bracket 41.

The leading edge guide assembly 110 is similarly secured to mounting bracket 141 via engagement of the upper threaded shaft 118a in the threaded opening 140 as described above in regard to the trailing edge guide assembly. The mounting bracket 141 is removably secured to a second mounting arm 143 of the saw mill assembly by one or more fasteners, such as cap screws 144 which pass through corresponding openings in a lower surface of the mounting arm 143 and engage a pair of corresponding threaded holes 142a . . . 142j formed in the mounting bracket 141. The leading edge guide mounting bracket 141 differs from the trailing edge mounting bracket in that several threaded holes 142a . . . 142j are formed in the upper surface thereof to permit the width of the cutting area D to be adjusted to accommodate materials of differing sizes. For example, by aligning the cap screws 144 with holes 142a and 142c, a relatively wide piece of material may be cut, while alignment of the cap screws 144 with holes 142h and 142j would accommodate a relatively narrow piece of material. It is understood that the use of multiple holes to provide adjustment of the width of the cutting area D is not limited to just the leading edge mounting bracket, but that said holes could be provided in the trailing edge mounting bracket, or both, to accomplish the same objective.

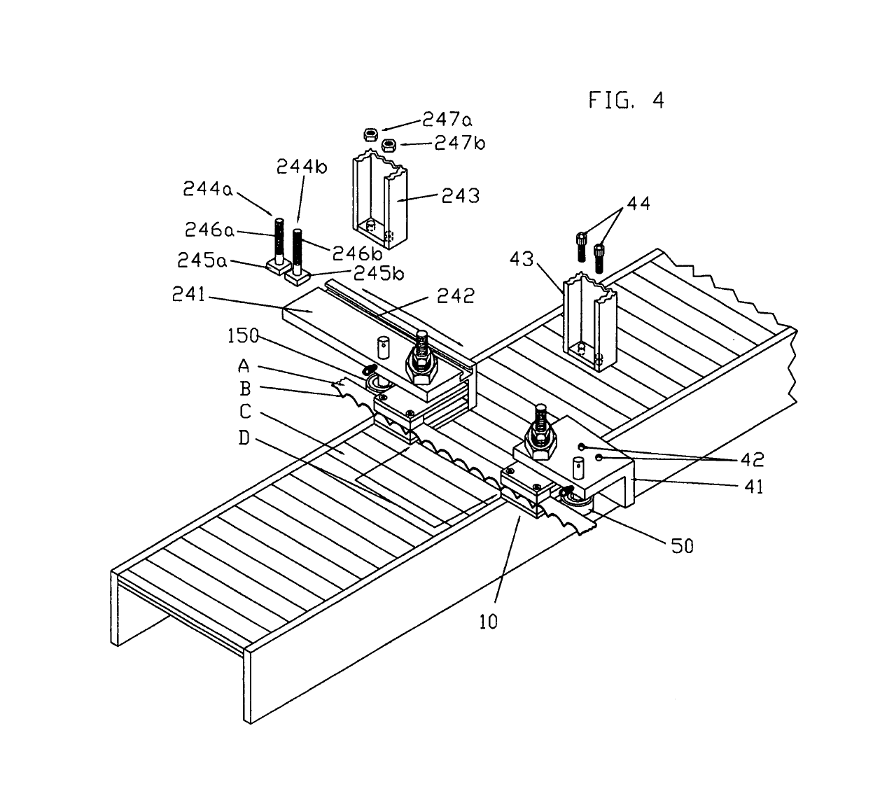

According to an alternative preferred use and operation of the embodiment of the present invention shown in FIGS. 4 & 5, two guide assemblies 10, 110 are utilized to stabilize a saw blade A. As in the embodiment shown in FIGS. 2 & 3, a cutting area D is defined above a conveyor C that feeds material to be cut between the trailing edge guide assembly 10 and leading edge guide assembly 110. The components of the leading edge guide assembly 110 are identical to the components of the trailing edge guide assembly 10, wherein like numerals (ie, 14, 114) indicate like component parts. Accordingly, the component parts of the leading edge guide assembly will not be described further.

The trailing edge guide assembly 10 is secured to mounting bracket 41 via engagement of the upper threaded shaft 18a in the threaded opening 40 as described above with regard to the embodiment shown in FIGS. 1-3. The mounting bracket 41 is removably secured to a first mounting arm 43 of the saw mill assembly by one or more fasteners, such as cap screws 44 which pass through corresponding openings in a lower surface of the mounting arm 43 and engage corresponding threaded holes 42a, 42b formed in the mounting bracket 41.

The leading edge guide assembly 110 is similarly secured to mounting bracket 241 via engagement of the upper threaded shaft 118a in the threaded opening 140 as described above with regard to the embodiment shown in FIGS. 1-3. According to this embodiment of the present invention, the mounting bracket 241 includes a T-shaped slot 242 for slidably receiving one or more fasteners such as bolts 244a, 244b. Each fastener 244a, 244b has an enlarged head section 245a, 245b that is shaped to be slidably received in slot 242. A threaded section 246a, 246b of each fastener projects outwardly from the opening in the T-shaped slot and passes through a corresponding opening in the bottom surface of the second mounting arm 243. Nuts 247a, 247b are threaded onto the threaded sections 246a, 246b of the fasteners 244a, 244b.

When the nuts 247a, 247b are fully tightened, the mounting bracket 241 and leading edge guide assembly 110 are secured against lateral movement due to the frictional engagement of the upper surface of the mounting bracket 241 and lower surface of the second mounting arm 243. The position of the leading edge guide assembly 110 relative to the trailing edge guide assembly 10, and correspondingly the width of the cutting area D, can be adjusted by loosening the nuts 247a, 247b to release the friction fit between the upper surface of the mounting bracket 241 and lower surface of mounting arm 243, thereby permitting the bolt heads 245a, 245b to freely slide in the T-slot 242. Once the desired width D is achieved, the nuts 247a, 247b can be tightened again to secure the position of the leading edge guide assembly 110. It is understood that the use of the T-slot configuration to provide adjustment of the width of the cutting area D is not limited to just the leading edge mounting bracket, but that said T-slot could be provided in the trailing edge mounting bracket, or both, to accomplish the same objective.

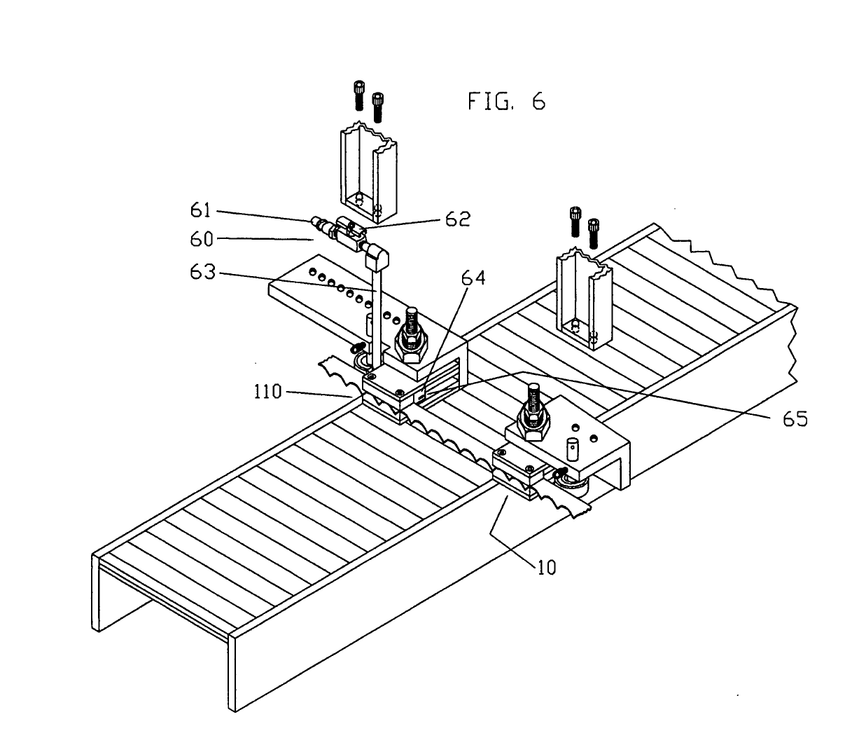

As shown in FIGS. 6 & 7, the device according to the preferred embodiments shown in FIGS. 2 & 4 can be used in conjunction with a blade de-dusting mechanism 60 for cleaning the kerf of a work piece as generally described in U.S. Pat. No. 6,412,380 B2. The de-dusting mechanism 60 includes an air supply line 61 that is connected to an external source of compressed air, an air supply valve 62 for controlling the amount of air provided, an air feed line 63, and block member 64. The block member 64 contains an interiorally threaded blind hole or socket forming an air inlet port located near one side of the block member, which port opens upwardly, as viewed, onto an upper surface thereof. The block member 64 also contains a hollow passageway which extends parallel to and is spaced from the back edge of the blade A to an opening or air outlet port 65 located on a side thereof which faces a work piece, not shown, when the guide is in its operative position in the mill. When the leading edge guide 110 is in its operative position, it is important that the opening 65 be disposed very close to the same level as that of the blade A. The socket can thus be fitted in an air tight manner with a conventional exteriorly threaded connector of an air hose leading to an externally located high pressure air source such that high pressure air (100-150 PSI @ 10-20 CFM) can be directed into the air inlet port, thence through the passageway and out of the opening 65 close to and directed alongside the back edge of the blade A and against a work piece being operated on by the mill to blow saw dust from the kerf formed by the blade A.

Although the present invention has been illustrated and described herein with respect to certain preferred embodiments, it is not intended that this patent should be limited in scope and coverage by such details other than as specifically set forth in the following claims.

I claim:

1. A guide for stabilizing a saw blade, said guide comprising:
a first guide block assembly comprising:
a first guide block having a first surface for engaging a first surface of said saw blade and a second opposing surface;
a first mounting plate affixed to said second opposing surface of the first guide block proximate a first end thereof; and
a first positioning shaft having a first end affixed to said first mounting plate proximate to a second end thereof; and a second end received in a mounting bracket of a saw mill;
a second guide block assembly comprising:
a second guide block having a first surface for engaging a second surface of said saw blade and a second opposing surface;
a second mounting plate affixed to said second opposing surface of said second guide block proximate a first end thereof; and
a second positioning shaft having a first end affixed to said second mounting plate proximate to a second end thereof; and a second end received in said mounting bracket of said saw mill.

2. The guide of claim 1 wherein said second positioning shaft is coaxial with said first positioning shaft.

3. The guide of claim 2 wherein said first positioning shaft is hollow and said second positioning shaft is coaxially received in the hollow opening therein.

4. The guide of claim 3 wherein the second positioning shaft includes threads formed in the outer surface thereof for rotatably engaging corresponding threads on the inner surface of the hollow first positioning shaft.

5. The guide of claim 4 wherein the first positioning shaft further includes threads formed in the outer surface thereof for rotatably engaging corresponding threads formed in an opening in the mounting bracket.

6. The guide of claim 5 further comprising a first securing nut threadably engaging the outer threaded surface of said first positioning shaft, said securing nut being rotatable with respect to said first positioning shaft such that a surface of the securing nut engages a first surface of said mounting bracket upon rotation into engagement therewith thereby securing the position of the first guide block relative to the first surface of the saw blade.

7. The guide of claim 6 further comprising a second securing nut threadably engaging the outer threaded surface of said second positioning shaft, said second securing nut being rotatable with respect to said second positioning shaft such that a surface of the securing nut engages an upper end surface of said first positioning shaft upon rotation into engagement therewith thereby securing the position of the second guide block relative to the second surface of the saw blade.

8. The guide of claim 5 further comprising a polygonally shaped head proximate the second end of said first positioning shaft.

9. The guide of claim 8 further comprising a polygonally shaped head proximate the second end of said second positioning shaft.

10. The guide of claim 1 wherein the first guide block assembly is positioned on the upper side of the saw mill and the second guide block assembly is positioned on the lower side of the saw mill.

11. The guide of claim 10 wherein the mounting bracket is positioned on the upper side of the saw mill.

12. The guide of claim 1 wherein the mounting bracket includes means for adjusting the lateral position of the guide in relation to the longitudinal axis of the saw blade.

13. The guide of claim 12 wherein the adjusting means comprises:
a plurality of holes disposed in a surface of the mounting bracket and aligned along a longitudinal axis thereof;
a mounting arm positioned on the saw mill, said mounting arm having one or more openings in a surface thereof; and
one or more fasteners inserted through said one or more openings in the mounting arm and a corresponding one or more of the plurality of holes in the mounting bracket.

14. The guide of claim 13 wherein said one or more fasteners are threaded bolts and said plurality of holes each include corresponding female threads.

15. The guide of claim 12 wherein the adjusting means comprises:
a longitudinal slot formed in a surface of the mounting bracket parallel to the longitudinal axis of the saw blade;
a mounting arm positioned on the saw mill, said mounting arm having one or more openings in a surface thereof; and
one or more fasteners, each having an enlarged head slidably positioned in the slot and an elongated shaft extending upwardly therefrom through said one or more openings in the mounting arm.

16. The guide of claim 15 further comprising one or more threaded nuts for engaging threaded portions of the elongated shafts of said one or more fasteners.

17. The guide of claim 12 further comprising a de-dusting mechanism having an air supply line for supplying compressed air to a nozzle positioned between the first guide block assembly and second guide block assembly along a back edge of the saw blade.

18. A guide assembly for a saw mill having an adjustable width cutting area comprising:
a first mounting bracket removably affixed to a first mounting arm of the saw mill, said first mounting bracket having a first guide block assembly removably affixed thereto;
a second mounting bracket removably affixed to a second mounting arm of the saw mill, said second mounting bracket having a second guide block assembly removably affixed thereto, wherein the cutting area is defined by the space between said first guide block assembly and said second guide block assembly, and
means for adjusting the lateral position of the first guide block relative to the second guide block.

19. The guide assembly of claim 18 wherein the adjusting means comprises:
a plurality of holes disposed in a surface of the second mounting bracket and aligned along a longitudinal axis thereof;
one or more openings in a surface of the second mounting arm; and
one or more fasteners inserted through said one or more openings in the second mounting arm and a corresponding one or more of the plurality of holes in the second mounting bracket.

20. The guide assembly of claim 19 wherein said one or more fasteners are threaded bolts and said plurality of holes each include corresponding female threads.

21. The guide assembly of claim 18 wherein the adjusting means comprises:
a longitudinal slot formed in a surface of the second mounting bracket parallel to the longitudinal axis of the saw blade;
one or more openings in a surface of said second mounting arm; and
one or more fasteners, each having an enlarged head slidably positioned in the slot and an elongated shaft extending upwardly therefrom through said one or more openings in the second mounting arm.

22. The guide assembly of claim 21 further comprising one or more threaded nuts for engaging threaded portions of the elongated shafts of said one or more fasteners.

23. The guide assembly of claim 18 further comprising a de-dusting mechanism having an air supply line for supplying compressed air to a nozzle positioned between the first guide block assembly and second guide block assembly along a back edge of the saw blade.

24. The guide assembly of claim 18, wherein
said first guide block assembly comprises:
a first guide block having a first surface for engaging a first surface of said saw blade and a second opposing surface;
a first mounting plate affixed to said second opposing surface of the first guide block proximate a first end thereof; and
a first positioning shaft having a first end affixed to said first mounting plate proximate to a second end thereof; and a second end received in a mounting bracket of a saw mill; and
said second guide block assembly comprises:
a second guide block having a first surface for engaging a second surface of said saw blade and a second opposing surface;
a second mounting plate affixed to said second opposing surface of said second guide block proximate a first end thereof; and
a second positioning shaft having a first end affixed to said second mounting plate proximate to a second end thereof; and a second end received in said mounting bracket of said saw mill.
